(19) United States
(12) Patent Application Publication
(10) Pub. No.: US 2002/0022979 A1
(43) Pub. Date: Feb. 21, 2002

(54) System and method for the automated release of a vehicle to one of a plurality of different users

(76) Inventors: Richard E. Whipp, Fort Wayne, IN (US); Charles Aurentz Klerner, Fort Wayne, IN (US)

Correspondence Address: BAKER & DANIELS, 111 E. WAYNE STREET, SUITE 800, FORT WAYNE, IN, 46802

(21) Appl. No.: 09/912,958

(22) Filed: Jul. 25, 2001

Related U.S. Application Data
(63) Continuation-in-part of application No. 09/602,741, filed on Jun. 23, 2000.

(51) Int. Cl. G06F 17/60

(52) U.S. Cl. 705/5

(57) ABSTRACT

An automated vehicle release system including a centralized data management system and a vehicle to be released to one of a plurality of users. The vehicle may have original equipment window glass, a local computer in wireless communication with the centralized data management system, and an interactive interface including the window glass and a touch sensor associated with the window glass. The touch sensor is in communication with the local computer, and the interactive interface is accessible by the user from outside the vehicle and through the window glass. The centralized data management system receives data entered into the local computer by the user via the interactive interface. Release of the vehicle to the user is authorized by the centralized data management system in response to the data entered by the user and is actuated by the local computer in response to an authorization signal received from the centralized data management system. Alternatively, instead of the vehicle having an interactive interface including the window glass, a user interface to the system may include a communication device separate from and located outside the vehicle and in selective communication with the local computer or the centralized data management system, release of the vehicle to the user through the local computer being in response to the data received from the communication device and the local computer having received the authorization signal from the centralized data management system.

Continuation-in-part of U.S. patent application Ser. No. 09/602,741, filed Jun. 23, 2000.

### BACKGROUND OF THE INVENTION

The present invention relates to a system and method for the automated release of a vehicle to one of a plurality of different users. One embodiment of the present invention provides an automated car rental system which minimizes fixed assets at the point of rental.

Numerous automated vehicle rental systems and motor pools have been proposed in the art. The references describing these systems point out the powerful appeal of the automobile as a transportation device, noting that autos allow direct point to point transportation, while freeing the driver and passengers from a rigid schedule. Many references point out that a transportation regime based on a pool of autos leased for short terms is more efficient than individually owned cars and provide environmental benefits. Individually owned cars are typically used infrequently and spend most of the time parked. A regime which keeps cars on the road in the hands of someone with an actual need to go somewhere would require less space for parking and fewer cars. Essential to making a rental version of such a system work in a geographically dispersed setting is reducing the labor requirements and the infrastructure dedicated to support the leasing of the vehicles. The greater the reduction in labor and the fewer elements of immobile infrastructure required at the point of leasing, the more widespread the leasing system may be made. From a cost standpoint, an ideal leasing system has no point of lease labor or infrastructure at all, allowing the widest possible dispersal of vehicles consistent with a reasonable return on investment in the vehicles.

There are limits to reducing point of lease costs in any leasing system. In an automated vehicle rental system, security of the vehicles to prevent theft, vandalism, and crime targeting patrons of the leasing system is a concern. Providing a reasonable level of security while keeping the system easy to use is desirable. Ensuring that vehicles are kept properly maintained is also an issue. Further, it is desirable that components of the system are protected from the elements; preferably, these components should be packaged, to the furthest extent possible, within the vehicle, rather than mounted externally.

Further still, it is desirable that such a system be adapted to a vehicle with minimal changes to the vehicle's structure or appearance. Modifications to the vehicle structure may compromise its structural integrity, increase costs, and adversely affects its resale value upon its being retired from the pool. If the appearance of the vehicle is substantially altered, at least externally, a potential user's attraction to the vehicle may be adversely affected and he or she may then be more likely to avoid leasing the vehicle. Moreover, if the outward appearance of the vehicle is substantially altered, a renting user may be more easily identified as a tourist, and thus as a target for certain types of crime.

Moreover, modifications to the vehicle which involve externally mounting components of the release system may result in damage to the vehicle or those components. For example, the elements or some automatic carwashes may damage externally mounted components. It is preferable, therefore, to keep at least the exterior of the vehicle as original as possible.

The prior art teaches a certain minimal set of features addressing issues faced by any automated motor pool allowing remote access to or leasing of automobiles. In general such features include a central control facility, some form of wireless communication between the vehicle and the central control facility, a customer and user identification protocol, typically system specific but potentially as expansive as using credit cards, secure systems for the transfer of data from the vehicle to the central control facility, and some sort of access control to the vehicles. Exemplary of the references addressing automated and semi-automated car rental systems is U.S. Pat. No. 5,289,369 to Hirshberg. Hirshberg '369 teaches an automated car rental system for a fleet of vehicles which handles security by prior selection of customers (called subscribers) and limiting the vehicles in a fleet to the limits of a city. Subscribers are provided machine-readable identification devices, such as magnetically-readable cards. Vehicles may be leased, or dropped off, at any one of a number of identified parking places within a city. Vehicles in the system of Hirshberg '369 are modified to incorporate a computer and include radio communications equipment for exchanging data with a central office. Each vehicle further includes an alarm actuable by the computer. The vehicles have displays visible from the vehicle exterior which indicate whether that vehicle is leased or not. The central control station tracks the location of vehicles in the system.

A subscriber uses the Hirshberg system by swiping his or her identification card through the card swipe externally mounted to the vehicle. Determining the customer's authorization to use the vehicle is then processed by either the onboard computer or by a central control station with which the computer on the vehicle communicates. The onboard computer or central station controls access to the trunk, opening and locking of the car doors and opening and locking of the hood determined by the authorization received.

Problems associated with the Hirshberg system include unavailability of a vehicle to other than preselected customers or subscribers whom are issued identification cards. Further, the Hirshberg system does not lend itself to release of a vehicle to one of a plurality of different, non-preselected users; it is therefore unsuitable for a system by which a random user may rent the vehicle. Moreover, externally-mounted components such as the card swipe risk damage by vandals, the elements or possibly an automatic carwash. Further still, in accordance with the Hirshberg system, the vehicle's use is geographically limited to within the limits of a city.

One or more variations on basic automated vehicle rental and car sharing systems appear in several other references, including U.S. Pat. No. 3,624,608 to Altman, U.S. Pat. No. 5,726,885 to Klein, et al., U.S. Pat. No. 5,812,070 to Tagami, et al., and U.S. Pat. No. 3,665,397 to DiNapeli, et al., and German Offenlegungsschrift DE-OS 22 10088. Several of these references are explicit applications of such systems to intra-urban settings. The systems are often contemplated as providing relief to parking demands within a specific urban area, and the use of the vehicles is restricted to that urban area.

Perhaps in part a consequence of the limited territorial application of the systems contemplated by the prior art, the art does not consider the complications, particularly legal complications, raised by operating an automated rental system across State or Provincial boundaries, or complications associated with operating such a system in different markets or under varying market conditions. In particular, the prior art does not consider the need to adjust the rental interface presented at the vehicle, both to ease customer use, and to accommodate legal changes, and local cost and market factors.

Nor does the prior art contemplate providing a vehicle released to a user of such a system through an intuitive, interactive and reconfigurable interface which is accessible by the user from outside the vehicle and which does not require substantial modification to the structure or external appearance of the vehicle. Such an interface would protect the components of the system, eliminate the need to modify the vehicle structure and/or exterior appearance, apprise a potential user of whether the vehicle is available for use and of the terms by which the vehicle may be released, and facilitate remotely-controlled modification of these terms to reflect, for example, changes in rental terms based on cost changes, market influences or geographic location of the vehicle.

Further, the prior art does not contemplate a vehicle release system having an intuitive, interactive and reconfigurable interface by which information, selection options or data entry fields are communicated to a potential user, and which is contained entirely within the vehicle. Nor does the prior art contemplate a user obtaining the release of a vehicle previously reserved or otherwise authorized for his or her use through an automated system which, when contacted by the user via any of a number of communication devices, remotely unlocks and enables the vehicle.

Such capabilities would provide a vast improvement over the prior art and would be highly desirable, not only for vehicle rental applications, but for other applications in which a vehicle may be automatically released to one of a plurality of different users, whom may be random, non-preselected users, or preselected users already having some association or relationship with the releasing authority.

### SUMMARY OF THE INVENTION

An object of the invention is to provide a car rental system minimizing labor costs and local infrastructure support required to lease a vehicle from a remote site.

Another object of the invention is to provide a highly intuitive interface for a customer utilizing the system.

Yet another object of the invention is to make the end user interface configurable to reflect local rental policies to broaden system geographical coverage and revise the terms by which release of the vehicle may be obtained based on local cost and marketing factors.

Still another object of the invention is to provide an end user interface which is accessible to the user located outside the vehicle, and which is disposed wholly within the vehicle to protect it from the elements and damage, reduce vehicle modification costs, and preserve the vehicle's retail value upon retirement from the pool. Such an interface may communicate vehicle release terms, selection options and data input fields to a potential user, and include a touch screen through which the user may communicate with the system. Such an interface may facilitate all, or only a part of, the entire transaction dialogue between the user and the system.

Yet another object of the invention is to provide a system by which a vehicle may be released to one of a plurality of different users which may or may not be preselected or members of a particular group. Such users may be persons desiring to rent the vehicle. A non-preselected user may be, for example, an individual who desires to use the vehicle, but is not a member of a select group (e.g., a preferred customer club member), or who has not reserved the vehicle for his use. A preselected user may be, for example, an individual who desires to use the vehicle and has reserved the vehicle for his use, is a member of a select group, or has some other previously established association with the vehicle-releasing entity by which release of the vehicle to him may be more easily facilitated.

An additional object of the present invention is to provide an end user interface separate from and located outside of the vehicle, and which includes a communication device accessible to a potential user, by which the end user may obtain release of the vehicle. Such devices may include, for example, a landline or cellular telephone, or an internet browser running on a computer, by which the user, whom has a reservation or is otherwise authorized to use the vehicle, may contact the releasing authority at the time vehicle release is desired. The vehicle may then be remotely unlocked and enabled by the releasing authority automatically. Where such vehicles are reserved for the use of authorized, preselected users, e.g., preferred rental customer club members, the need for a reconfigurable visual interface is obviated, such an embodiment of the present invention would further reduce vehicle modification costs and the potential for damage to system components.

The present invention is directed to an automated release system for a geographically dispersed fleet of vehicles. The automated system operates under the control of a centralized data processing management system. Each of the plurality of vehicles in the fleet of vehicles may have an interactive interface including a touch screen. This interface is accessible by a user from outside the vehicle but may be located entirely within the vehicle to better protect components of the system from the elements and possible damage, maintain the outward appearance of the vehicle, and reduce costs associated with modifications thereto.

Moreover, structural modifications to the vehicle in adapting it to the system are minimized: In one embodiment of the present invention, the original equipment window glass of the vehicle serves as the user's tactile interface. A flexible touch screen is mounted to the interior surface of the vehicle's original equipment window glass using a substantially transparent optical adhesive. The touch screen itself is also substantially transparent and allows the user to view the graphical displays of the monitor positioned behind the touch screen. The monitor is particularly positioned relative to the touch screen so that, as the user interfaces with the monitor display through the touch screen, the user may merely touch the point on the exterior surface of the window glass which immediately overlies, and corresponds to, a selected portion of the monitor display.

In other embodiments of the present invention, the need for a touch screen or reconfigurable visual display is obviated by the user securing release of the vehicle via a communication device located outside the vehicle and accessible to the potential user. This device may be, for example, a landline or cellular telephone, or an internet browser running on a computer. These embodiments are further described hereinbelow.

On board each vehicle is a local computer. In embodiments having a touch screen interface, the local computer on each vehicle is connected to the interactive interface for the control thereof. User activation through the interactive interface initiates access to a communication facility which supports data links between the centralized data processing management system and the local data processing systems installed on each vehicle. The dialogue is presented as part of the interactive interface, under the immediate control of the local computer, and presented in a sequence and with content usually established by the centralized data processing management facility to ensure conformance to the State or Provincial law of the locality. The local computer is connected to an interactive display for control of the interactive interface generated thereon. The local computer collects data from users through the interactive interface and relating to vehicle conditions identified by assorted sensors mounted on the vehicle. User activation of computer procedures through the interactive interface initiates the display of a dialogue through the interface and activates a communication facility supporting data links to the centralized data processing management system. The data collected from the users may then be transmitted over data communication links to the centralized data processing management system. The centralized data processing management facility includes a database management system, a database including records indicating status and location of the vehicles, with the database implementing hierarchal policies used for adjusting the adjustable dialogues and rental agreements for each vehicle to conform with rules and policies in effect at the current vehicle location.

The present invention provides an automated rental system for a fleet of vehicles, including a centralized automated management system, and a configurable interactive interface for each vehicle accessible by a user from outside the vehicle for obtaining release of the vehicle, as by, for example, renting it, a local data processing system installed on each vehicle and connected to the configurable interactive interface for the control thereof, and a communication facility supporting data links between the centralized automated management system and the local data processing systems installed on each vehicle.

The present invention also provides an automated vehicle release system including a centralized data management system and a vehicle to be released to one of a plurality of users. The vehicle has a local computer in wireless communication with the centralized data management system, an interactive interface which may include a touch screen in communication with the local computer and being accessible by the user from outside the vehicle, and means for unlocking the vehicle and means for allowing starting of the vehicle, both of the means being in communication with and controlled by the local computer. The centralized data management system receives data entered into the local computer by the user via the interactive interface, and release of the vehicle to the user is selectively authorized by the centralized data management system in response to the data entered by the user. The means for unlocking the vehicle and the means for allowing starting the vehicle are enabled by the local computer in response to the authorization sent by the centralized data management system, whereby the vehicle is released to the user.

The present invention further provides a method for releasing a vehicle to one of a plurality of different users, including: receiving data by a user located outside the vehicle through an interactive interface including a touch screen into a local computer located inside the vehicle; communicating the data entered into the local computer to a centralized data management system remotely located relative to the vehicle; selectively issuing an authorization for release of the vehicle to the user from the centralized data management system in response to the data entered by the user; communicating the authorization from the centralized data management system to the local computer; and automatically unlocking the vehicle and facilitating its starting in response to the authorization received by the local computer from the centralized data management system.

Moreover, the present invention provides an automated vehicle release system including a centralized data management system and a vehicle to be released to one of a plurality of users. The vehicle has original equipment window glass, a local computer in wireless communication with the centralized data management system, and an interactive interface including the window glass and a touch sensor associated with the window glass. The touch sensor is in communication with the local computer, and the interactive interface is accessible by the user from outside the vehicle and through the window glass. The centralized data management system receives data entered into the local computer by the user via the interactive interface. Release of the vehicle to the user is authorized by the centralized data management system in response to the data entered by the user and is actuated by the local computer in response to an authorization signal received from the centralized data management system.

Still further, the present invention provides a method for releasing a vehicle to one of a plurality of different users, including: receiving data from a user located outside the vehicle, through the original equipment window glass of the vehicle and a touch sensor in communication with the window glass, into a local computer located inside the vehicle; communicating the data entered into the local computer to a centralized data management system remotely located relative to the vehicle; communicating an authorization based on the data entered by the user from the centralized data management system to the local computer; and permitting access by the user to the vehicle in response to the authorization received by the local computer from the centralized data management system.

The present invention also provides an automated vehicle release system including a centralized data management system, a vehicle for release to one of a plurality of users, the vehicle having a local computer in wireless communication with the centralized data management system, and a user interface to the vehicle release system including a communication device separate from and located outside the vehicle, the interface being in selective communication with the local computer or the centralized data management system. Data entry by the user through the interface is received by the local computer or the centralized data management system and, in response to data entered by the user, release of the vehicle is actuated by the local computer.

The present invention also provides a method for releasing a vehicle to one of a plurality of different users, including: receiving data entered by a user through a communication device outside and separate from the vehicle, with a centralized data management system remote from the vehicle or a local computer located in the vehicle; authorizing release of the vehicle to the user through the centralized data management system; establishing communication between the centralized data management system and the local computer; sending an authorization signal from the centralized data management system to the local computer; and releasing the vehicle to the user through the local computer in response to the data received from the communication device and the local computer having received the authorization signal from the centralized data management system.

Additional effects, features and advantages will be apparent in the written description that follows.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a diagrammatic depiction of a vehicle rental system in accordance with the present invention;

FIG. 2 is a schematic view of the rental system shown in FIG. 1;

FIG. 3 is a block diagram of the vehicular electronic components used to implement one embodiment of the rental system with a fleet of vehicles;

FIG. 4 is a state diagram for a vehicle in a rental fleet in accordance with the present invention;

FIG. 5 is a block diagram of a centralized, automated data management system in accordance with the present invention;

FIG. 6 is a side view of one embodiment of a vehicle including the inventive release system;

FIG. 7 is an enlarged, fragmentary view of the vehicle of FIG. 6, showing its interactive touch screen interface through original equipment window glass of the vehicle;

FIG. 8 is a fragmentary, sectional rear view of the vehicle of FIG. 7, showing a user interfacing with the touch screen through the vehicle's original equipment window;

FIG. 9 is a fragmentary perspective view of the interior of the vehicle of FIG. 6, showing one embodiment the interactive touch screen interface mounted against the interior surface of a window of the vehicle and one embodiment of the local computer mounted to a vehicle bulkhead;

FIG. 10 is another view of the interior of the vehicle of FIG. 9, showing an alternative embodiment of the local computer;

FIG. 11 is an exploded view of the CPU housing of the local computer of FIG. 10; and

FIG. 12 is an interior perspective view of the window of the vehicle of FIG. 10, showing an alternative embodiment of the interactive touch screen interface mounted against the surface of the original equipment window glass.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein are not to be construed as limiting the scope of the invention in any manner.

### DETAILED DESCRIPTION OF THE INVENTION

The embodiments disclosed below are not intended to be exhaustive or limit the invention to the precise forms disclosed in the following detailed description. Rather, the embodiments are chosen and described so that others skilled in the art may utilize its teachings.

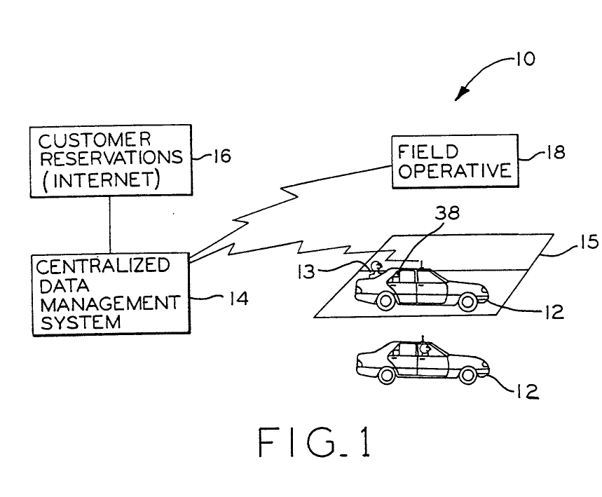

One embodiment the inventive system facilitates an unattended car rental system. FIG. 1 is a diagrammatic depiction of a vehicle rental system 10 in accordance with the present invention. Vehicle rental system 10 comprises a plurality of vehicles 12, which may be leased or rented by an end user or customer 13 at a remote, unattended site 15. As used herein the term “end user” should be taken to mean a customer unless otherwise specified. Vehicles 12 may have other users, such as maintenance workers and field operatives.

Customer 13 rents a vehicle 12 by using an interface which includes externally accessible interactive interface 38. In one embodiment, interface 38 is a configurable display provided with a touch screen. This touch screen may include part of, or be installed in place of, a vehicle window, and may be accessed from outside the vehicle. Other embodiments of the present invention, discussed further hereinbelow, include interfaces having a touch screen which includes part of the vehicle's original equipment window, or a communication device accessible to the user and which is separate from, and located outside the vehicle, such as, for example, a landline or cellular telephone, or an internet browser running on a computer. It is also envisioned that alternatives to these interfaces might include a voice activated system including a small microphone located outside the vehicle. It is further envisioned that some embodiments of vehicle 12 may have a perimeter sensing device, similar to that used in commercially-available car alarm systems, by which a potential renter entering the proximity of the vehicle is greeted by a recorded voice message which advises that the vehicle is available for hire.

In the car rental system shown in FIG. 1, following a customer's entry of data or upon the occurrence of other factors described below, communications are established between a vehicle 12 and automated, centralized data management system 14, which is generally not collocated with the point of lease at a location 15. Vehicles 12 already under lease are generally not in communication with the centralized data management system 14. Communication is by a secure data link. Such data links may be established using a mix of wireless telephone, broadband, cellular, satellite and other technology. No one mix of equipment is required over the fleet as a whole. The automated, centralized data management system 14 also generates automated messages to a field operative 18 who may visit locations 15 to inspect and maintain vehicles 12. If desired, data system 14 may also take vehicle reservations over the internet. The centralized data management system 14 can then alert vehicle 12 that it is “reserved” and cause an appropriate message to be displayed locally. Generally, once rented, vehicles 12 will not contact the data system 14 until termination of the lease unless an emergency occurs.

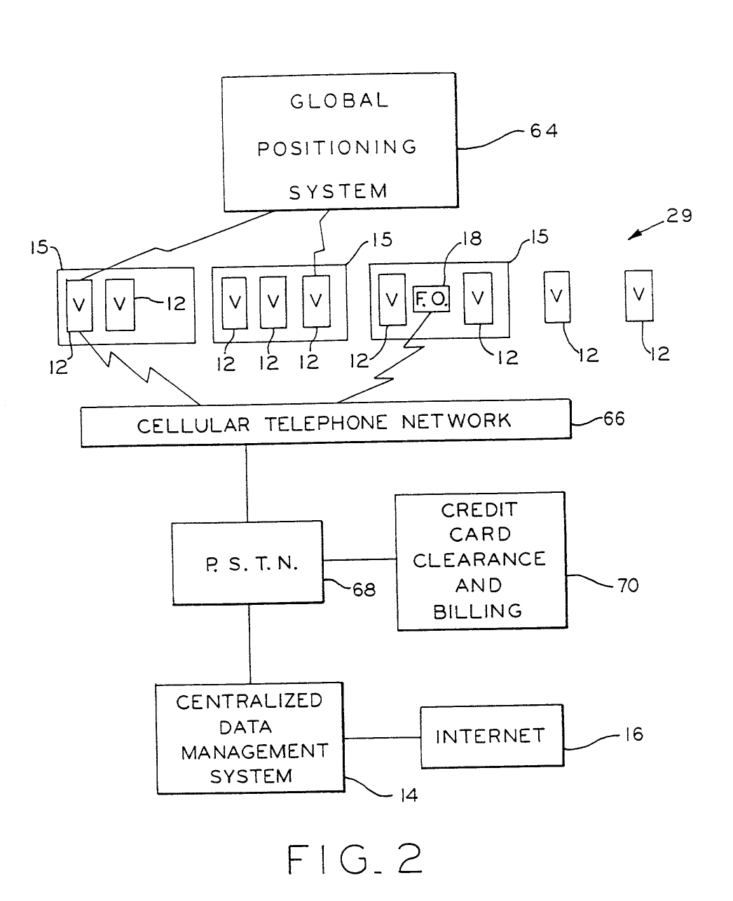

FIG. 2 is a block diagram illustration of the major components of the rental system of this embodiment of the present invention. A fleet 29 of a plurality of vehicles 12 is dispersed among a plurality of geographically isolated parking facilities 15 or in the hands of lessees. At any given moment one or more vehicles 12 parked at a parking facility 15 may utilize signals from the earth orbiting satellites of the global positioning system 64 (GPS) to report its location to the data system 14. A vehicle 12, which a customer is leasing, may also be in contact with the automated, centralized data management system 14 via a cellular phone or satellite in the event of an emergency. The link may be conventionally completed by connection of cellular network 66 to the public switched telephone network (P.S.T.N.) 68 to the centralized data management system 14. Similarly, connections may be initiated from the centralized data management system 14 to any one of vehicles 12 or to a telecommunication device carried by a roaming field operative 18 assigned to inspect and maintain the vehicles 12. It is envisioned that a commercially-available service such as OnStar™, which employs satellite communication technology, may be utilized to facilitate the data and/or communication link between the vehicle and data management center computers, and tracking of the vehicle through the GPS.

Leases are processed by the centralized data management system 14 which generates records relating to lessees and authorizes the release of vehicles 12 to end users. Authorization is conventionally, and automatically, handled over the telephone network 68 or via internet connections with a credit card clearance center 70 while wireless communication links are in place between vehicles 12 and the centralized data management system 14. Additionally, the centralized data management system 14 may support interactive content servers accessible over the internet 16. Such servers can implement data gathering, interactive webpages, information services and the like supporting a vehicle reservation system and other end user subscription functions.

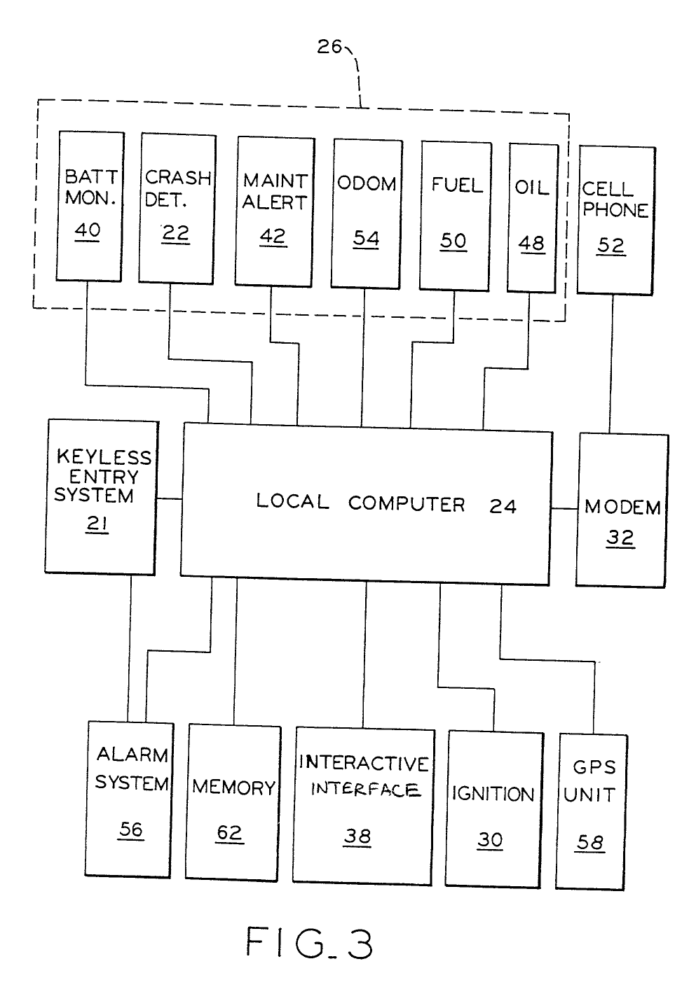

FIG. 3 is a block diagram illustrating components installed on vehicle 12 to implement the rental system of the invention or monitored by the rental system for maintenance or other reasons. A keyless entry system 21, which is a conventional feature of many contemporary automobiles, may be included on all vehicles 12. As is also conventional, the keyless entry system may be connected to a vehicle alarm system 56. Both keyless entry system 21 and alarm system 56 communicate with a local computer 24, which in turn may attempt to alert the centralized data management system 14 over a communication link. A modem 32 and cell phone 52 are one way of establishing such a link although any other form of wireless communication, such as satellite communications technology, can be used. Local computer 24 may be based on conventional personal computer technology to reduce costs and may include conventional memory 62 including any one or more of a hard drive, RAM and ROM. The computer may be constructed from laptop or industrial grade components to better withstand temperature extremes, shock, vibration, dust and humidity depending upon the geographical locale of the vehicle.

Potentially, a commercial operating system which can handle standard dial out and dial in communications may be used. Preferably the operating system can support the systematic requirements of the computer system described herein. This encompasses a touch screen and other interfaces as well as data communications. Further, it is envisioned that the code of programs facilitating the operation of local computer 24 may be embedded into one or more chips therein, in the manner well-known in the art of automotive computer controls, which can minimize the costs and package space requirements of local computer 24, and further improve the robustness of the system.

Local computer 24 may be used to monitor one or more of the members of a sensor group 26, which may include by way of example a battery level monitor 40, a crash detector 22 (such as an air bag activation circuit), a maintenance alert computer 42, the vehicle's odometer 54, the vehicle's fuel level sensor 50, and the vehicle's oil level or pressure sensor 48. In addition, the statuses of the vehicle locks and ambient temperature may be monitored. Appropriate input interfaces may be provided to convert sensor signals into a form suitable for use by local computer 24.

Local computer 24 controls the vehicle's ignition 30 and has access to an onboard GPS unit 58. An interactive interface 38 provides for the communication of information stored locally or downloaded from the centralized system 14, and supports the entry of data by the end user. The type of data to be entered by the user (e.g., user name, driver's license number, credit card number, and any selections to be chosen by the user) are identified to the user by the interface. Interactive interface 38 may comprise a touch screen flat panel display which, in this embodiment of the present invention, may be the only physical end user interface to rental system 10. The display includes a touch screen sensor that acts as the equivalent of a mouse button and operates at high resolution. An example of such a system is a flat panel touch screen display available from, for example, 3M Corporation, and is capable of generating a high resolution color output as well as sufficient touch screen resolution commensurate with fine display detail. The flat panel is mounted to a vehicle 12, preferably in place of a portion of the window glass immediately behind the driver position in a vehicle 12. The original window glass would be retained to replace the flat display upon retirement of a vehicle 12 from the fleet. The flat panel is to be mounted to allow easy access by a renter, to minimize frontal exposure of the screen surface, to minimize modifications to the vehicle, to allow cables to be easily connected to the display, to minimize the potential for passenger injury in case of accident, and to reduce the potential for vandalism and theft. Alternatively, as discussed further hereinbelow, the inventive system may include an interactive user interface having a touch screen which includes a portion of one of the vehicle's original equipment windows, which are typically not flat, and which preserves the structural integrity of the vehicle and its exterior appearance. This alternative obviates the need for original equipment window removal and replacement with a flat display panel, and reduces costs associated with incorporating a vehicle into the inventive system.

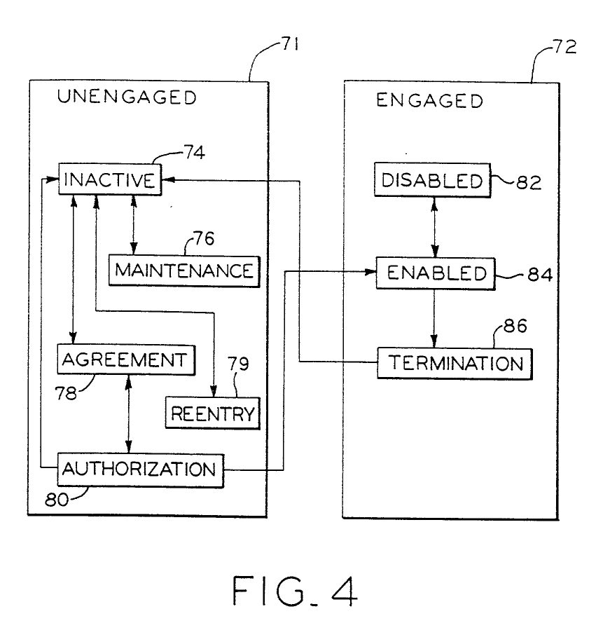

FIG. 4 is a state diagram illustrating the transitions between vehicle modes. Local computers 24 on vehicles 12 in the rental system 10 of the present invention are state systems. At any given time vehicles 12 (or more properly their local computers 24) are in one and only one combination of state and mode, e.g., engaged and enabled. Vehicles 12 exhibit substantially different characteristics when rented as opposed to unrented. External events initiate changes in mode and possibly state.

A vehicle 12 may be in an engaged state 72 (e.g., leased or otherwise released to the end user) or an unengaged state 71 (e.g., not leased). An unengaged vehicle may be taken to be initially in an inactive or base mode 74 from which the vehicle may be leased or passed to maintenance. The maintenance mode 76 occurs only for unengaged vehicles 12, and involves a change in mode from the inactive mode 74. Such a change may occur upon query by the central data management facility 14, or by operation of a field operative 18. The only change in mode status permitted from the maintenance mode is back to the inactive mode 74. During the maintenance mode 76 the vehicle is unavailable for hire, as new software may be downloaded or performance checks done. In the inactive mode 74 the local computer 24 and the interactive display 38 are in a power saving condition to reduce the drain of power on a vehicle battery. Vehicle battery voltage level is monitored and if it falls below a predetermined minimum level, the vehicle may be started, manually or via local computer 24, and run to recharge the battery. The use of interactive display 38 is available only to field operatives and maintenance workers during maintenance mode 76. Maintenance workers may be allowed to override the engaged state.

System state may also move from the inactive mode 74 to an agreement mode 78. In some embodiments, this occurs upon an end user touching the interactive display 38. In agreement mode 78 local computer 24 and interactive display 38 are fully powered. Because a potential renter may discontinue the agreement steps for any one of a variety of reasons, status from the agreement mode 78 may return to the inactive mode 74. In agreement mode 78 the prospective renter steps through a series of information entry and agreement validation. This series may, in some embodiments, include a variety of screen images. The specific series or screen images that are presented depend upon the political jurisdiction where the rental takes place and, possibly, vehicle specific or other locale specific settings.

Information entry via the interface may include entry of information such as driver's license number, name, . . . etc. . . . Where interface 38 comprises a touch screen, displays are provided which permit the entry of this information. A simulated keyboard may be generated as a part of interactive display 38 to ease entry of the requested information. Further, it is envisioned that local computer 24 may be provided with a program such as, for example, MicroSoft Paint™, to accommodate, if necessary, recordation of the user's signature, which may be entered through the interface's touch screen with a fingertip, stylus, . . . etc. . . . Once all entry and agreement displays are completed, credit card billing information is entered and the system enters authorization mode 80. The entire process may be timed to reset itself in case of prolonged pauses in the entry of data.

Completion of the basic agreement steps passes the vehicle mode from agreement mode 78 to authorization mode 80 during which the vehicle 12 contacts the data management system 14. Authorization may be refused under circumstances where the system allows the prospective renter to try again, or under circumstances in which the user will be restricted from retrying. For example, authorization may be refused because a credit card was “over limit” or the centralized data management system 14 was unable to contact the credit card clearing organization 70 within a predetermined time limit. If, for example, a card indicated as being over limit was used, the user can be invited to try again using a streamlined process in agreement mode 78. If, on the other hand, a non-trivial result is obtained, such as indication that the card is stolen, inactive mode 74 is entered and held for a predetermined minimum period. Once authorization is granted, the authorization signal is communicated from central data management system 14 to local computer 24, the state of the vehicle passes from unengaged state 71 to engaged state 72 and to enabled mode 84, and the vehicle is released to the user.

Upon entry into the enabled mode 84, the local computer 24, via the keyless entry system 21, unlocks the vehicle's doors, and enables ignition 30. Control of locks and the ignition may be done in any conventional way, such as through electrical switching controlled by local computer 24. In some embodiments, the ignition switch may be a simple, keyless switch that operates exactly like a keyed switch, and in engaged state 72 the vehicle acts like a conventional vehicle except that no keys are provided. At times the user will wish to temporarily leave a vehicle 12 and lock it, without giving up the lease. With the vehicle remaining in the engaged state 72, the user exits the vehicle 12 and, in some embodiments, may select a lock option on interactive display 38. The user is prompted for a number or password for later reentry. Once the information is entered, the vehicle mode moves from enabled mode 84 to disabled mode 82. In disabled mode 82 the vehicle is locked and the ignition is disabled. The vehicle mode may be returned to enabled mode 84 by entry of the password, or the original credit card, driver's license information or both.

Alternatively, the ignition switch may be enabled by the local computer and the renter may use the vehicle's original pass key for starting the vehicle and regaining access thereto. Automobile pass keys are now typically provided with a resistor, transponder or microcircuit-containing chip which is matched to a receptor mounted in the ignition system and paired to the pass key. Conventionally, insertion of the pass key into the ignition switch typically completes a circuit which allows the vehicle to be started upon turning of the key in the ignition switch. The key may or may not be inserted in the ignition switch at the time of vehicle release to the user; if not, it may be stored out of sight by being inserted into an inconspicuous compartment inside the vehicle. This compartment may be provided with a slot into which the key is inserted, and with a receptor by which the key's insertion in the slot is verified. Providing the user with the pass key allows the user to gain reentry to the released vehicle without necessitating interaction with system interface 38, and until the lease is terminated the vehicle remains in its engaged state. With the pass key removed from the ignition switch, however, the vehicle may enter disabled mode 82 within engaged state 72. To terminate the lease, and ensure the key is returned with the vehicle, it is envisioned that the user be required to leave the pass key in the ignition switch, or in the above-mentioned slot, upon finally leaving the vehicle. Depending on the embodiment of the interface and/or ignition switch used, reminders to this effect may be displayed on the interface display in lease termination mode, or elsewhere on the vehicle. It is envisioned that alternative embodiments of the present invention having no touch screen interface, discussed hereinbelow, would use a removable pass key.

Also from the enabled mode 84 the user may move to terminate the lease through termination mode 86 by selection of the option on the interactive display 38. In the termination mode 86 the user is apprised of the length of the rental, mileage, fuel levels before the rental commenced and current and the final charges invoiced to the user's credit card. Embodiments of interface 38 comprising touch screen interfaces may be provided with optional displays to allow the entry of damage information, vehicle problems, notes to the billing department, etc. The user is given the option of having the invoice e-mailed, posted or faxed. The GPS unit 58 may be queried to compare vehicle 12 location to determine if the vehicle has been returned to the proper or agreed location 15. It is envisioned that in alternative embodiments of the present invention having no touch screen interface, discussed hereinbelow, vehicle mode may pass from the enabled mode to the termination mode by the user contacting local computer 24 or the releasing authority (which may be represented by centralized data management system 14) via a communication device such as a telephone or computer internet browser which serves as interface 38.

In the event that a renter later returns to the vehicle 12 because of misplaced or forgotten belongings, an option will be provided from the inactive mode 74 upon entry of the credit card and driver's license information of the immediately previous renter. In reentry mode 79 vehicle 12 is unlocked but the ignition 30 remains disabled. Upon closing the vehicle 12, inactive mode 74 is reentered and the doors are locked.

An alternative embodiment of the inventive release system provides vehicles 12 to be released to preselected users such as those whom have previously arranged reservations or are otherwise members of a preselected group of users having an existing arrangement or relationship with the releasing authority. For example, such a preselected user may be someone having previously made a reservation, or a member of a rental company's preferred customer club. A user having already made a reservation for use of the vehicle obtains prior authorization for release of the vehicle. At the desired time of release, such as when the user arrives at location 15, the user may contact centralized data management system 14 through a communication device, such as a landline or cellular telephone, or an internet browser running on a computer, which serves as interface 38. As a further alternative, the user may contact local computer 24 of a particular vehicle 12 through the communication device, and the local computer would, in turn, establish communications with centralized data management system 14 to verify authorization for release and receive the authorization signal. During this contact to either centralized data management system 14 or local computer 24, the user may enter minimal amounts of data via the communication device, for example, a previously arranged code such as a reservation confirmation number. Authorization having been previously established by the centralized data management system 14, in response to either receiving the data entered by the user, or from the local computer, as the case may be, the authorization signal is communicated by centralized data management system 14 to local computer 24, which automatically unlocks the doors and enables the ignition.

Another alternative would preload the reservation information and authorization from centralized data management system 14 to the local computer of a particular vehicle 12. The user, upon arrival at location 15, contacts that local computer via the communication device and enters the appropriate code, such as the reservation number. Having already received the authorization signal from centralized data management system 14, local computer 24, in response to the data entered by the user, unlocks the doors and enables the ignition, thereby releasing the vehicle to the user.

A potential user whom is a member of a preselected group of users, such as rental customer preferred customer club, and whom has not already established a vehicle reservation, may similarly streamline the release process through contacting centralized data management system 14 and entering his club membership number and identifying his present location 15. A code particular to that location 15 may be made known to a potential user prior to or at his time of arrival there. Such a user would have previously provided to the releasing authority his driver's license and credit card information; this data is stored by centralized data management system 14 and is associated with the user's membership number. Because the user need not reenter this data via communication device 38 (e.g., cell phone) at the desired time of release, his proceeding quickly through agreement and authorization modes 78 and 80 is facilitated. Authorization, once established by centralized data management system 14, is communicated thereby to local computer 24 of a particular vehicle 12, the identity of which is provided via communication device 38 to the user. A vehicle may be identified, for example, by a serial number or its license number. That vehicle is then automatically unlocked and its ignition enabled in response to receiving the authorization, and thus released to the user.

The above-described alternative embodiments would streamline the release process for preselected users at the time and location of vehicle pickup, when he may be least able to, or unreceptive to the prospect of, entering substantial amounts of data due to time constraints or merely the desire to quickly arrive at his destination.

A further alternative embodiment in which vehicle 12 need not be provided with an interactive interface 38 comprising a touch screen display allows a non-preselected potential user seeking to obtain release of a vehicle 12 to contact centralized data management system 14 or that vehicle's local computer 24 via a communication device as described above, and during that contact proceed through agreement mode 78 wherein he would enter all necessary information (e.g., name driver's license number, credit card number, . . . etc. . . .) and make appropriate selections using the communication device as interface 38. It is envisioned that voice recognition software may be employed by centralized data management system 14 or local computer 24, as the case may be, to facilitate data entry when a telephone serves as interface 38. Once this data has been entered by the user, centralized data management system 14, which may receive the data directly from communication device 38 or via local computer 24, as the case may be, communicates the authorization signal to the local computer, which unlocks vehicle 12 and enables its ignition, thereby releasing the vehicle to the user. Terms by which release may be obtained may be communicated to the potential user aurally or visually, depending on the type of communication device 38 used. It is recognized, however, that certain types of communication devices serving as interfaces 38 may be better suited to communicating large amounts and/or certain types of information, such as contract terms, to the potential user, and that this embodiment of the inventive vehicle release system may be better suited for use with only certain types of communication devices 38 or transactions.

In accordance with the above-described embodiments of the present invention, release of the vehicle to the user is accomplished without the need for providing an on-board interactive visual interface such as a touch screen, thereby further reducing the cost associated with incorporating a vehicle into the inventive release system.

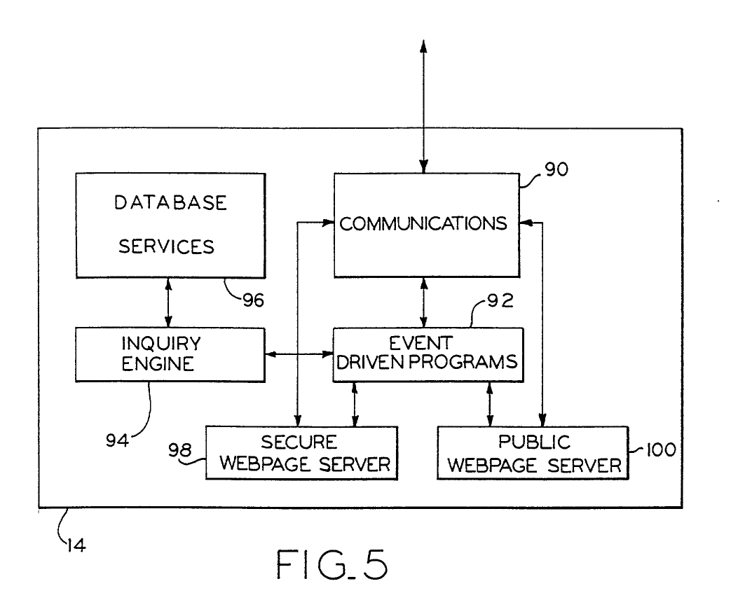

FIG. 5 is a block diagram of the automated, centralized data management system 14 of the present invention. Data management system 14 is a stateless, event-driven processor. Data management system 14 responds to a number of random or simultaneous events. Any call from a vehicle 12 requires that the system 14 answer the call and set up a secure, encrypted data link. A request to approve a renter would typically include contacting a credit card approval agency and return notification of approval or disapproval to the vehicle 12. In a State or Province requiring validation of a driver's license, approval may also involve contacting a State or Provincial authority charged with issuing driver's licenses to determine currency of a license. Conventional event-driven programs 92 handle such operations, with communication being handled by communications subsystem 90, which may include modems, ISDN modems, TCP/IP software, firewalls and other conventional networking components. Human administrative interaction with system 14 may be done through web browser programs running on computers connected to system 14 over a local area network, a wide area network, the internet or an intranet. Any internal interactive content server 98 executing on the system 14 and utilizing communications subsystem 90 will handle the exchange of data between system 14 and the web browser.

Among other tasks handled by event driven programs 92 are those relating to changes in mode of a vehicle 12 in the rental fleet. For example, termination mode 86 involves the collection of rental information and vehicle 12 location and the calculation of charges. Billing is passed to the appropriate credit card billing agency 70. Entries are passed to accounts receivable and an automated message is issued to a field operative 18 to inspect the vehicle 12. Vehicles 12 may also contact data management system 14 to report low fuel levels, a message which also results in an automated call to a field operative 18 to refuel the vehicle. A number of maintenance issues can also be the source of calls, including particularly a battery low voltage situation.

In addition, data management system 14 handles a number of conventional data processing center functions, although individual administrative tasks may be geographically disbursed. Data management system 14 supports one or more system status displays that are configurable depending upon the size of the system. Database services 96 are provided to support these displays. Database files, managed from the data management system 14 are provided for vehicles 12, locations 15, and equipment and inventory information. Records within the database files for each vehicle 12 include fields relating to vehicle model and color, vehicle identification numbers (VIN), vehicle group, maintenance history, vehicle equipment, assigned location, state, mode, current alerts (e.g. low fuel), and various statistics (percentage of time leased), . . . etc. . . . Records for location files include fields for the physical latitude and longitude of the vehicle location, identification of field operatives 18 for that location and other contacts, and definable arrangements about the location. Records may also be maintained on renters.

Data management system 14 includes inquiry engine 94 for accessing database services 96 to generate displays of selected data. Inquiry engine 94 allows the collection of data relating to vehicle status including location and state. Rental transactions including date, time, fuel, mileage, vehicle ID, renter and authorization data may be obtained. Customer information may be extracted for marketing analyses including name, vital statistics from the driver's license, credit card information, preferred renter history and rental history. Event driven programs 92 further include accounting packages, which may be conventional commercial packages. Conventional accounting reports are provided.

If desired, data management system 14 may support public interactive application server 100. The interactive application may access database services 96 within limitations. All access to the public interactive application occurs through communications subsystem 90, on which are maintained conventional security precautions, e.g. a fire wall, anti-virus applications, . . . etc. . . .

Database services 96 may also be configured to supply different sets of interface displays for vehicles 12 depending upon their respective current locations 15 to conform with local laws. In order to meet the need for flexibility for vehicle and location specific billing and operational settings, hierarchical policies are also provided. Any policy is a collection of settings which relate in an hierarchal fashion to other, more global policies.

Policies are used to specify rental requirements, calculate rental charges and fix other operational practices. Under fixed corporate settings exist locale and vehicle group settings. For example, a locale group is named “Colorado” and under that locale group another locale subgroup named “Arapaho Basin Ski Area” could be made. Colorado may specify hourly rates and a requirement for driver license number verification, having inherited from Company policy required entry fields for social security number and credit card number. The Arapaho Basin Ski Area may specify a particular fuel rate. Having locale and vehicle group (and child group) policies allows rapid changes to rental policies to be implemented. Promotional discounts or high demand premiums may be implemented for a given city or vehicle class without affecting other areas or vehicles. The legal differences between locales may be handled by changes in policies for different locales.

The relationship of vehicles 12 and vehicle groups is a direct function of the vehicle model. However, the relationship of vehicles 12 to locales is dynamic. A vehicle 12 may be manually assigned to a locale, or it may be automatically updated by the reported location of the vehicle from the onboard GPS unit 58. The automatic method allows vehicles to roam between locales, always automatically adhering to policies for vehicle group and locale without administrative intervention.

The above-discussed embodiment of the inventive system provides a car rental system which minimizes labor costs at the point of rental by implementing automated access to rental vehicles. Vehicles may be rented without any on site human intervention on the part of the leasing entity. Infrastructure support required to lease a vehicle from a site is also minimized since all of the equipment to be used is installed on the vehicle itself. All that may be required in terms of infrastructure support at the pickup point is a parking place. Interactive interfaces may be readily reconfigured to improve ease of use and may adapt dialogue, under the control of either closed face computer or a central processor to meet local legal needs or user requests. The user interface for a customer is kept intuitive by maintaining its simplicity at every step of the rental process.

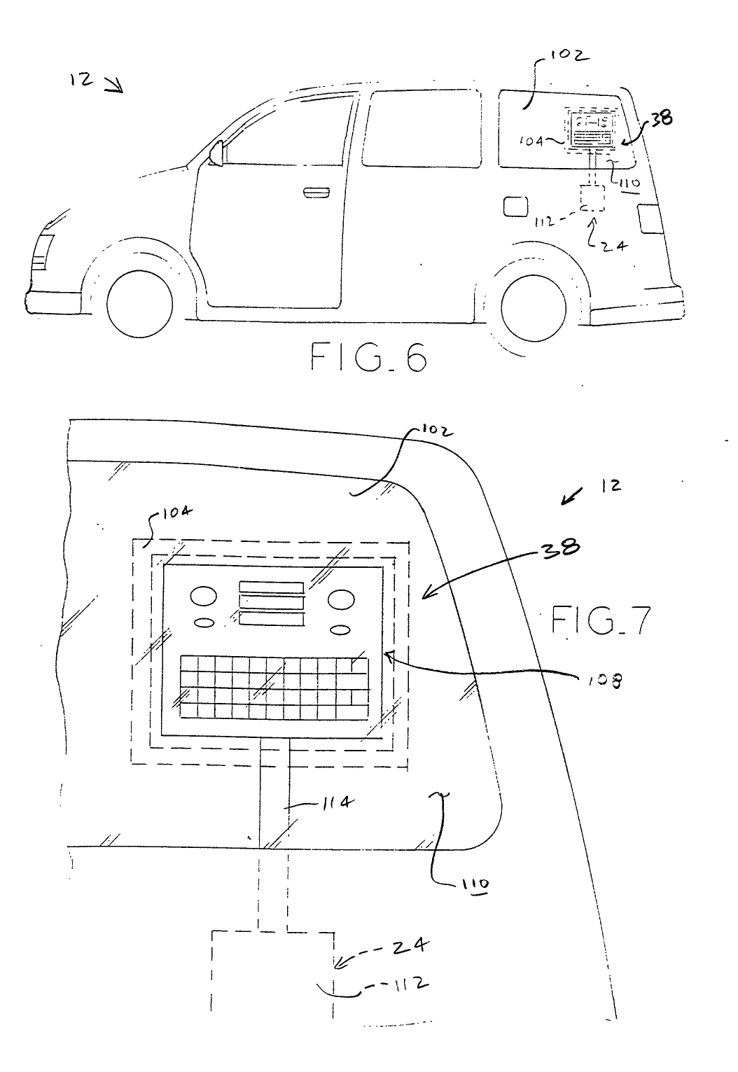

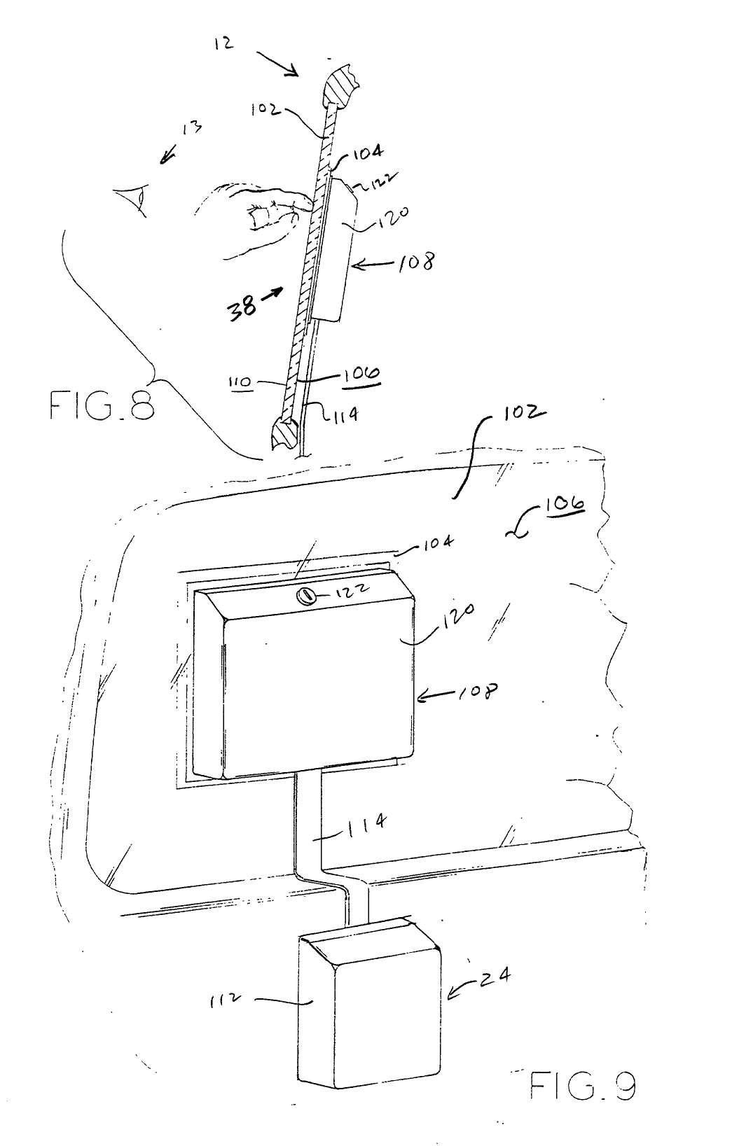

Referring now to FIGS. 6-8, there is shown an embodiment of a vehicle 12 in which one of its original equipment windows 102, which may be nonplanar, forms part of the interactive interface 38. As used herein, the term “original equipment window” refers to a window conforming to the design of the window as installed on the vehicle by its manufacturer; original equipment window glass thus encompasses the window as originally installed in the vehicle at its point of manufacture, or a replacement window which is substantially identical in shape and size, and designed to serve as a replacement window.

Capacitive touch sensor 104 is mounted to interior surface 106 of original equipment window glass 102 by means of a substantially transparent optical adhesive. Touch sensor 104 is of the type described in U.S. Pat. No. 5,650,597, issued Jul. 22, 1997, the disclosure of which is expressly incorporated herein by reference. Touch sensor 104 comprises a plurality of electrically conductive horizontal indium tin oxide (ITO) sensor bars applied to a substantially transparent, or at least translucent, and flexible polyester substrate sheet approximately 7 mils thick. The polyester sheet easily conforms to the curved surfaces commonly found on vehicle windows. It is envisioned, however, that touch sensor 104 may comprise ITO sensor bars which are directly adhered or otherwise fixed or applied to window glass 102. Moreover, it is envisioned that touch sensor 104 may comprise a planar substrate which is placed in close enough proximity with the original equipment window glass to facilitate its proper operation.

The ITO sensor bars are themselves substantially transparent, and thus the display of computer display monitor 108 is visible through touch sensor 104. Touch sensor 104 is particularly positioned relative to monitor 108 such that portions of the display generated by the monitor which correlate to input points to be selected by the user, are located proximate to locations on the touch sensor directly opposite locations on exterior window surface 110 touched by the user in entering data or selecting various choices in interfacing with local computer 24. The user may enter data merely by touching portions of window surface 110 which overlie touch sensor 104. The location on the exterior surface of the window glass touched by the user in entering data is detected and correlated with a portion of the interface display and the computer thus receives input from the user. This detected input corresponds to the particular sensor bar, and the location along that bar, which senses the user's touch through the window glass. This touch screen technology is available from 3M Corporation, where it is referred to as Dynapro™ Near Field Imaging™.

Central processing unit (CPU) 112 of local computer 24 is in communication with touch sensor 104 and monitor 108 through wires 114. Alternatively, CPU 112 may be in communication with touch sensor 104 and monitor via the conductive vehicle or computer chassis, a wireless communication device, or any other suitable means. A controller within CPU 112 correlates the affected touch sensor bar, and the position therealong, with locations on the monitor display. Selection of monitor display portions via touch sensor 104 is similar in concept to making such selections through use of a mouse.

Monitor 108 may be mounted to vehicle 12 in any suitable manner. In FIG. 9, the monitor is mounted against or proximal the window; referring to FIG. 12, the monitor is supported by brackets 116 to window frame 118. Monitor 108 includes vented housing 120 which encloses interior components of the monitor. The interior of housing 120 is accessible through lock 122 to authorized persons for maintenance and repair as necessary.

It is envisioned that an embodiment of interactive interface 38 may be provided which does not include monitor 108 as shown, but which effectively functions, from the perspective of a user outside the vehicle, in a manner otherwise similar to monitor 108. Such an embodiment would comprise a laser projector (not shown) having a small cylindrical housing affixed to the headliner at the rear of the vehicle, and in communication with local computer 24 as monitor 108 would be. The interface display is projected onto the interior surface of touch sensor 104, much as a rear projection television image is projected onto the interior of its viewing screen. Data entry and selection by the user would be as described above, only the means by which the display images are presented to the user would be changed. Such a rear projection projector may be designed and adapted for use in the inventive system using technology developed or being developed by Nitor, a corporation based in San Jose, Calif. It is further envisioned that the substrate of touch sensor 104 need not be substantially transparent, or even translucent in such an embodiment. Instead, it may be substantially opaque and coated with a film which reacts to varying laser light incident thereon to provide the desired graphic effect.

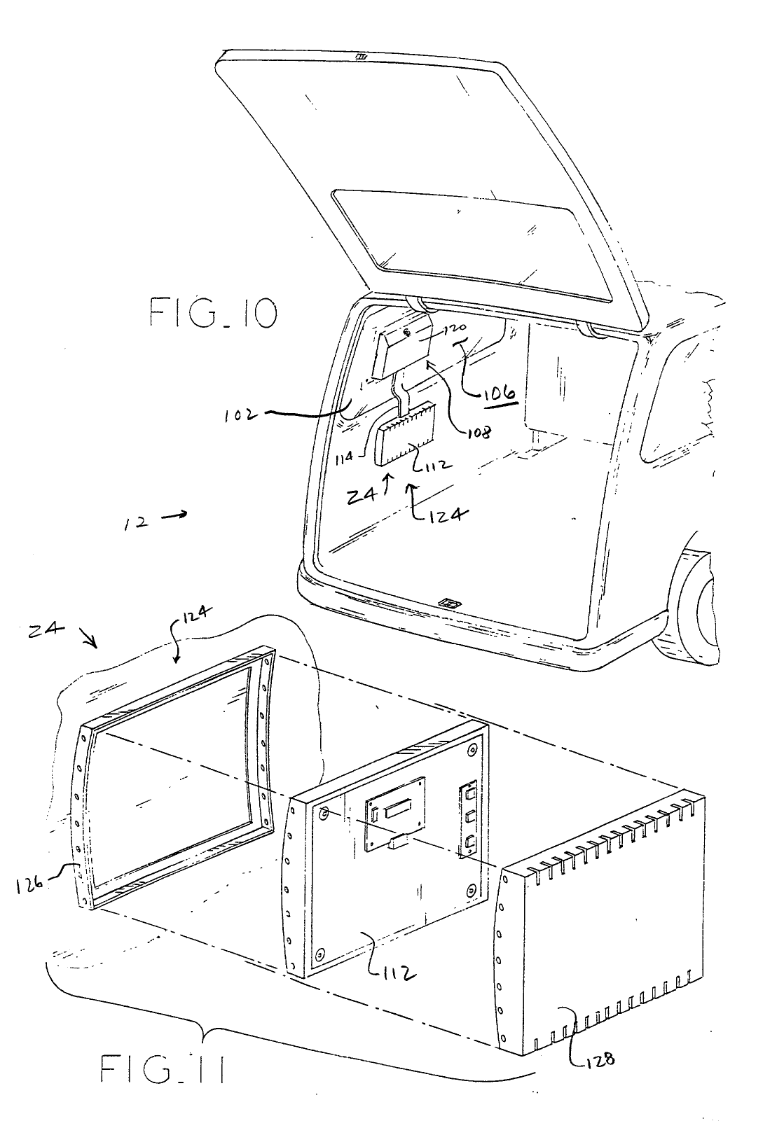

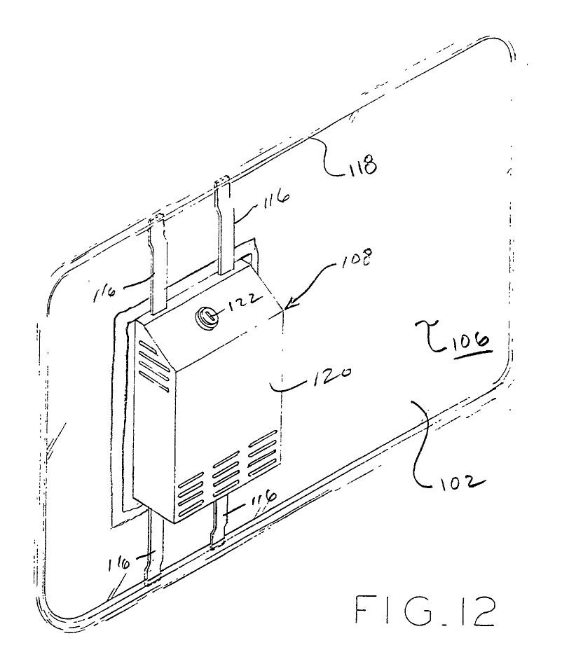

Referring to FIGS. 10 and 11, CPU 112 may be secured to vehicle interior bulkhead 124 at a location beneath window 102. FIG. 11 illustrates a CPU enclosure comprising frame 126, which is secured to the bulkhead and in which CPU 112 is seated, and vented cover 128 which encloses CPU 112 and is fastened to frame 126.

Those of ordinary skill in the pertinent arts will now appreciate that the above-described automated vehicle release system may be applied to other than vehicle rental systems. For example, the present invention may be readily incorporated into a fleet of pool vehicles, such as might be maintained by a government or corporate entity, whereby one of a plurality of different users (e.g., an employee) may have a vehicle in that fleet released to him.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An automated vehicle release system, comprising:
a centralized data management system; and
a vehicle to be released to one of a plurality of users, said vehicle having:
original equipment window glass,
a local computer in wireless communication with said centralized data management system, and
an interactive interface comprising said window glass and a touch sensor associated with said window glass, said touch sensor being in communication with said local computer, said interactive interface being accessible by the user from outside said vehicle and through said window glass;
said centralized data management system receiving data entered into said local computer by the user via said interactive interface, release of said vehicle to the user being authorized by said centralized data management system in response to the data entered by the user and being actuated by said local computer in response to an authorization signal received from the centralized data management system.

2. The automated release system for a vehicle of claim 1, wherein said original equipment window glass is nonplanar.

3. The automated release system for a vehicle of claim 1, wherein said touch sensor comprises a flexible, substantially transparent sheet in contact with an interior surface of said window glass.

4. The automated release system for a vehicle of claim 3, wherein said sheet is translucent.

5. The automated release system for a vehicle of claim 4, wherein said sheet is substantially transparent.

6. The automated release system for a vehicle of claim 3, wherein said sheet conforms to said window glass interior surface.

7. The automated release system for a vehicle of claim 3, wherein said sheet is adhered to said window glass interior surface.

8. The automated release system for a vehicle of claim 1, wherein said interactive interface further comprises a monitor in communication with said local computer, said monitor having a display which is visible through said window glass and said touch sensor from outside said vehicle.

9. The automated release system for a vehicle of claim 1, wherein said touch sensor is a capacitive touch sensor.

10. The automated release system for a vehicle of claim 9, wherein said capacitive touch sensor comprises a substantially transparent substrate sheet on which electrically conductive material has been applied.

11. The automated release system for a vehicle of claim 10, wherein said substrate sheet is flexible.

12. The automated release system for a vehicle of claim 11, wherein said substrate sheet is polyester.

13. The automated release system for a vehicle of claim 10, wherein said electrically conductive material is ITO.

14. The automated release system for a vehicle of claim 10, wherein said electrically conductive material is in the form of bars.

15. The automated release system for a vehicle of claim 14, wherein said bars are substantially horizontal.

16. A method for releasing a vehicle to one of a plurality of different users, comprising:
receiving data from a user located outside the vehicle, through the original equipment window glass of the vehicle and a touch sensor in communication with the window glass, into a local computer located inside the vehicle;
communicating the data entered into the local computer to a centralized data management system remotely located relative to the vehicle;
communicating an authorization based on the data entered by the user from the centralized data management system to the local computer; and
permitting access by the user to the vehicle in response to the authorization received by the local computer from the centralized data management system.

17. The method of claim 16, wherein access by the user to the vehicle is automatically permitted in response to the authorization received by the local computer from the centralized data management system.

18. The method of claim 16, wherein the vehicle is released to a user renting the vehicle.

19. The method of claim 18, further comprising displaying, to a user located outside the vehicle, terms by which the vehicle may be rented through the original equipment window glass of the vehicle and the touch sensor.

20. The method of claim 19, further comprising displaying the terms on a monitor mounted inside the vehicle and in communication with the local computer.

21. The method of claim 16, further comprising displaying, to a user located outside the vehicle, the type of data to be entered by the user through the original equipment window glass of the vehicle and the touch sensor.

22. The method of claim 21, further comprising displaying the type of data to be entered by the user to the user through the touch sensor and the window glass.

23. The method of claim 22, wherein the type of data to be entered by the user is displayed on a monitor located inside the vehicle and in communication with the local computer.

24. The method of claim 21, further comprising detecting with the touch sensor a location on the exterior surface of the original equipment window glass that the user has touched in entering data, and correlating that location with a portion of a display visible to the user through the touch screen and the window glass.

25. The method of claim 16, wherein the user is a member of a group of preselected potential users.

26. An automated vehicle release system, comprising:
a centralized data management system;
a vehicle for release to one of a plurality of users, said vehicle having a local computer in wireless communication with said centralized data management system; and
a user interface to said vehicle release system comprising a communication device separate from and located outside said vehicle, said interface being in selective communication with one of said local computer and said centralized data management system, data entry by the user through said interface being received by said one of said local computer and said centralized data management system;
wherein, in response to data entered by the user, release of the vehicle is actuated by said local computer.

27. The automated vehicle release system of claim 26, wherein said centralized data management system receives data entered into said interface by the user, said centralized data management system provides an authorization signal to said local computer in response to the data entered by the user, and release of the vehicle is actuated by said local computer in response to said local computer receiving the authorization signal from said centralized data management system.

28. The automated vehicle release system of claim 27, wherein said centralized data management system includes information provided by the user prior to said one of said local computer and said centralized data management system receiving data entered into said interface by said user, and release of said vehicle is in response to both the data entered by the user and the information provided by the user.

29. A method for releasing a vehicle to one of a plurality of different users, comprising:
receiving data entered by a user through a communication device outside and separate from the vehicle, with one of a centralized data management system remote from the vehicle and a local computer located in the vehicle;
authorizing release of the vehicle to the user through the centralized data management system;
establishing communication between the centralized data management system and the local computer;
sending an authorization signal from the centralized data management system to the local computer; and
releasing the vehicle to the user through the local computer in response to the data received from the communication device and the local computer having received the authorization signal from the centralized data management system.

30. The method of claim 29, wherein the data entered by the user is transmitted from the communication device to the centralized data management system.

31. The method of claim 29, wherein access by the user to the vehicle is automatically permitted at least partially in response to the authorization signal being received by the local computer from the centralized data management system.

32. The method of claim 31, wherein access by the user to the vehicle is automatically permitted in response to a combination of the authorization signal being received by the local computer from the centralized data management system and data entered by the user subsequently being received by the local computer from the communication device.

33. The method of claim 29, wherein the user is a member of a group of preselected potential users.

34. The method of claim 29, wherein the communication device is a telephone.

35. The method of claim 34, wherein the telephone is a cellular telephone.

36. The method of claim 29, wherein the communication device is an internet browser running on a computer.

37. The method of claim 29, further comprising, prior to receiving data entered by the user through the communication device, obtaining other user-specific information upon which the authorization is at least partially based.

38. The method of claim 37, wherein the vehicle is released to a user renting the vehicle.

39. The method of claim 38, wherein the other user-specific information includes at least one of a group consisting of credit card information and driver's license information.

40. The method of claim 29, wherein the vehicle is released to a user renting the vehicle, and the authorization is based upon information included in the data entered by the user through the communications device.
